(19) United States
(12) Patent Application Publication
(10) Pub. No.: US 2026/0210862 A1
(43) Pub. Date: Jul. 23, 2026

(54) PHOTOLUMINESCENCE IMAGING INSPECTION SYSTEM FOR MULTI-JUNCTION SOLAR CELLS

(71) Applicant: LIVESTRONG OPTOELECTRONICS CO., LTD., KAOHSIUNG CITY (TW)

(72) Inventor: Tzu-Huan CHENG, KAOHSIUNG CITY (TW)

(21) Appl. No.: 19/027,932

(22) Filed: Jan. 17, 2025

(51) Int. Cl. G01N 21/64; G01N 21/95

(52) U.S. Cl. CPC G01N 21/6489; G01N 21/6402; G01N 21/6456; G01N 21/9501

(57) ABSTRACT

A photoluminescence image inspection system for multi-junction solar cells is disclosed. The photoluminescence image inspection system includes a photoelectric excitation module adapted to illuminate a multi-junction solar cell to excite the multi-junction solar cell to emit light and includes a light source and a voltage source, wherein the light source is used to provide light irradiation to the multi-junction solar cell; the voltage source is used to provide a voltage to the multi-junction solar cell; a detection module disposed on one side of the photoelectric excitation module and adapted to capture a photoluminescence signal of the multi-junction solar cell; a filter module disposed in front of the detection module for filtering out light emitted from the light source in the same wavelength band as the photoluminescence signal of the multi-junction solar cell.

### BACKGROUND

### Technical Field

The present invention is related to an inspection device for a solar cell, and more particularly to an inspection device for multi-junction solar cells.

### Description of Related Art

Multijunction solar cells have attracted a lot of attention due to their high photoelectric conversion efficiency, especially in high-demand applications such as satellites and aerospace. However, the complexity of the multi-junction structure makes it easy to produce various defects during its manufacturing process, such as micro-cracks, dislocations, and junction inhomogeneities in the crystal structure. These defects will seriously affect the efficiency and life of solar cells. Therefore, accurate detection and analysis of the internal structure of multi-junction solar cells has become crucial.

Conventional inspection technology such as Electroluminescence (EL) technology, mainly incorporates a method of causing a solar cell to be excited and emit light by applying a voltage to the solar cell and then detecting the intensity and distribution of light to determine internal defects of the solar cell. Although the EL technology can detect most defects of the solar cells to a certain extent, the detection sensitivity and resolution thereof are limited. Especially in multi-junction structures, the EL technology makes it difficult to effectively distinguish defects between different junction layers of the solar cells. In addition, the detection of the EL technology needs to be carried out under the condition of battery operation. Such a detection method may be affected by the working status of the battery, resulting in unstable detection results.

Another commonly used detection technology is External Quantum Efficiency (EQE) measurement. The EQE measurement analyzes the performance of the solar cells by measuring the photoelectric conversion efficiency under irradiation of different wavelengths of light. However, this method is mainly used for an overall performance measurement of a solar cell and cannot accurately locate small internal defects. In addition, the EQE measurement requires a step-by-step wavelength scan process, which is time-consuming and less sensitive to small defects in multi-junction structures.

To overcome these limitations, Photoluminescence (PL) technology began to attract the attention of the industry. The Photoluminescence (PL) technology utilizes a light source to irradiate solar cells, causing them to emit excitation light which is related to the material's characteristics. Since the Photoluminescence (PL) technology does not require applying a voltage to the solar cell, the interference of the operation state to the detection result can be avoided. Also, the Photoluminescence (PL) technology has greater sensitivity, especially in detecting small defects. However, the existing PL inspection system still has shortcomings in detection speed and image processing capabilities, making it difficult to meet the real-time detection needs of large-scale production lines.

Therefore, a method that can perform efficient and high-resolution detection of multi-junction solar cells is needed for the industry, wherein the inspection technology can not only accurately identify and locate internal defects, but also be able to adapt to the online inspection needs of large-scale production lines. Hence, the present invention provides an inspection system for multi-junction solar cells and a method for using the same based on Photoluminescence (PL) technology, aiming to improve the accuracy and efficiency of detection of the solar cells.

### BRIEF SUMMARY OF THE INVENTION

The present invention provides a photoluminescence (PL) image inspection system for multijunction solar cells and a method for using the same to solve the deficiencies of the existing technology in defect detection sensitivity, resolution, and real-time performance. The photoluminescence (PL) image inspection system according to an embodiment of the present invention includes a photoelectric excitation module, a filter module, and a detection module, wherein the photoelectric excitation module includes a light source and a voltage source. The photoluminescence (PL) image inspection system according to the present invention can perform high-resolution PL image inspection on multi-junction solar cells and can effectively improve inspection efficiency and thus can be widely used in the quality control for solar cells.

According to an embodiment of the present invention, the photoluminescence (PL) image inspection system includes several core components. First, the photoluminescence (PL) image inspection system includes a light source with an adjustable wavelength for excitation, wherein an adjustable wavelength laser is used as the light source, with the wavelength ranging from 250 nm to 1500 nm to adapt to the different material and structure characteristics of the multi-junction solar cells. The adjustable wavelength laser can selectively excite specific junctions of the multi-junction solar cells, thereby improving the detection sensitivity of internal defects in different junction layers.

Second, the photoluminescence (PL) image inspection system utilizes a precise filtering technology. The photoluminescence (PL) image inspection system is provided with a multi-level filter that can filter out the emitted light of the light source and only allow the excitation light within a specific wavelength band to pass to the detection module. Therefore, the photoluminescence (PL) image inspection system according to the present invention can ensure the purity of the captured photoluminescence image signal and reduce interference from background noise, thereby improving detection accuracy.

Third, the photoluminescence (PL) image inspection system according to the present invention utilizes a high-sensitivity light detector. For example, the detection module of the photoluminescence (PL) image inspection system can include a high-sensitivity cooled charge-coupled device (CCD) or complementary metal oxide semiconductor (Complementary Metal Oxide Semiconductor, CMOS) camera or a hyperspectral instrument that can operate in low-light environments and reduce the impact of thermal noise through cooling devices. With the configuration mentioned above, the photoluminescence (PL) image inspection system according to the present invention can capture weak PL signals, thereby enabling the detection of tiny defects.

Fourth, the photoluminescence (PL) image inspection system according to the present invention utilizes an advanced image processing module. The photoluminescence (PL) image inspection system can incorporate advanced image processing technology, including image enhancement, edge detection, defect classification, and three-dimensional reconstruction algorithms. These technologies enable the detection module to process the captured PL images in a short time and accurately identify and locate various defects inside the solar cells, such as cracks, dislocations, heterojunction discontinuities, etc. The detection module can further support real-time defect analysis and can automatically report inspection results.

Fifth, the photoluminescence (PL) image inspection system according to the present invention includes multi-junction recognition capability. The photoluminescence (PL) image inspection system has a multi-junction recognition function and can conduct independent PL image detection for different junction layers. The function is achieved by adjusting the light wavelength of the light source for excitation during the detection process so that specific defects in different junction layers can be sensitively detected.

Sixth, the photoluminescence (PL) image inspection system according to the present invention includes a real-time detection and online application. The photoluminescence (PL) image inspection system can be designed to adapt to the needs of online quality control of large-scale production lines. The photoluminescence (PL) image inspection system has high detection speed and real-time image processing capability which enable the system to be integrated into automated solar cell production lines for real-time defect detection. The feature greatly improves the efficiency of quality control during the solar cell production process and helps to promptly identify and eliminate potential problems in production.

As mentioned above, as compared with the conventional PL image inspection technologies, the photoluminescence (PL) image inspection system according to the present invention greatly improves the detection accuracy, sensitivity, and application range. The photoluminescence (PL) image inspection system according to the present invention is not only able to accurately detect tiny defects in multi-junction solar cells but can also be applied to the production of solar cells of different types and sizes, providing strong quality assurance and extending the service life of solar cells.

### BRIEF DESCRIPTION OF THE DRAWINGS

FIG. 1 is a schematic diagram of a photoluminescence (PL) image inspection system according to a preferred embodiment of the present invention;

FIG. 2 is a block diagram of the photoluminescence (PL) image inspection system of FIG. 1;

FIG. 3 is a schematic diagram of a photoluminescence (PL) image inspection system according to another embodiment of the present invention; and

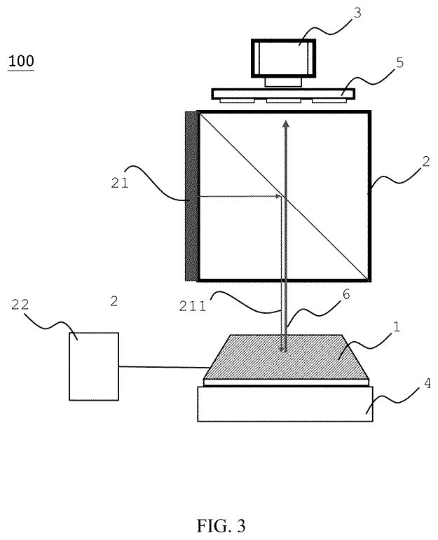

FIG. 4 is a diagram of the measurement result of a multi-junction solar cell by utilizing the photoluminescence (PL) image inspection system according to an embodiment of the present invention.

### DETAILED DESCRIPTION OF THE INVENTION

The present invention will now be described more fully hereinafter with reference to the accompanying drawings, in which example embodiments of the present invention are shown. The present invention may, however, be embodied in different forms and should not be construed as limited to the embodiments set forth herein. Rather, these embodiments are provided to make the technical features, contents, and advantages of the present invention more accessible to the persons skilled in the art.

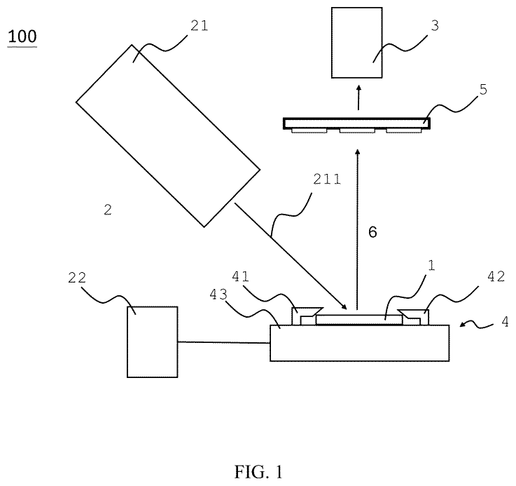

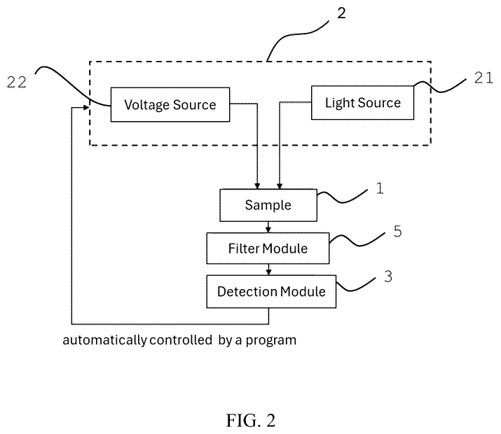

Referring to FIG. 1 and FIG. 2, the photoluminescence (PL) image inspection system 100 according to a preferred embodiment of the present invention is adapted to detect a photoluminescence image of a sample 1. The sample 1 is made of semiconductor material, such as a germanium semiconductor wafer having an epitaxial surface layer, or other types of multijunction materials, and the present invention is not limited thereto. The photoluminescence (PL) image inspection system 100 includes a photoelectric excitation module 2, a detection module 3, an electrode mechanism 4, and a filter module 5.

The photoelectric excitation module 2 includes a light source 21 and a voltage source 22. The light source 21 can emit detection light 211 with a wavelength smaller than the wavelength corresponding to the energy gap of the sample 1. When the detection light 211 irradiates the sample 1, the electrons inside of the material of the sample 1 can be excited and jump to an excited state, thereby leaving electric holes. Then, the electrons in the excited state return to a more stable lower energy level again and combine with the electric holes to form luminescent recombination and release light at the same time, which produces excitation light 6. This phenomenon is known as photoluminescence. The voltage source 22 can output a specific voltage to the electrode mechanism 4 to modulate the band structure of the sample 1, so that the distribution positions of the electrons and the electric holes of the material of the sample 1 after light excitation are modulated, thereby affecting the phenomenon of luminescent recombination. The detection module 3 can be a CCD or CMOS image sensing device or a hyperspectral instrument. The detection module 3 can include a cooling device to reduce the impact of thermal noise on the detection result of the sample 1. As shown in FIG. 1, the detection module 3 is positioned at one side of the photoelectric excitation module 2 and is adapted to capture the photoluminescence image and the spectral information of the sample 1. Further, the filter module 5 is incorporated with the detection module 3 to determine whether there is a defect on each junction of the sample 1. A passband of the filter module 5 is adjustable according to the type of the sample 1. By determining the brightness uniformity, brightness gradient, and gradient morphology of the captured image of the sample 1, it can be known whether there are scratches, hidden marks, or material defects on each junction of the sample 1.

The light source 21 can be a laser light source, an LED light source, or a light bulb. There is no limitation to the wavelength of the detection light 211, as long as the sample 1 can be excited to emit light after being irradiated by the detection light 211. For example, the wavelength of the detection light 211 can be between 250 nm and 1500 nm but is not limited thereto.

The voltage source 22 can be a constant current source, a constant voltage source, a variable voltage source, or a voltage source with an electric meter function, as long as the band structure of the material of the sample 1 can be adjusted after being applied with the voltage. Specifically, the voltage range of the voltage source 22 can be between −200V and 200V but is not limited thereto.

The electrode mechanism 4 is positioned below the sample 1 and is adapted to load the sample 1. The electrode mechanism 4 includes a sample holder 43, a first electrode 41, and a second electrode 42, wherein the first electrode 41 and the second electrode 42 are utilized as the positive and negative electrodes for the voltage source 22. The first electrode 41 and the second electrode 42 are used to electrically connect to the sample 1. The first electrode 41 and the second electrode 42 are adjustable to respectively contact the positive and negative electrodes of the sample 1 placed on the sample holder 43 and are not limited to contact the same surface of the sample 1 to meet the measurement requirements.

From the photoluminescence image of the sample 1, the luminescence characteristics of different junctions at any detection point thereof can be known. The photoluminescence characteristics are related to the purity, doping impurity concentration, dopant type, minority carrier lifetime, junction characteristics, surface recombination rate, built-in electric field, and photovoltaic characteristics, etc. of the sample 1. Therefore, from the photoluminescence image, information about the quality of materials, minority carrier lifetime distribution, junction characteristics distribution, surface recombination rate distribution, built-in electric field distribution and photovoltaic distribution of the sample 1 can be obtained.

According to the embodiments of the present invention, the excitation process of the sample 1 can be performed by utilizing the light source 21 or the voltage source 22 of the photoelectric excitation module 2, or a combination thereof. Especially, the sample 1 can be supplied with a specific bias voltage to detect a biased photoluminescence image (biased PL image) thereof. The photoluminescence image can reflect data close to the distribution of luminescence characteristics of different junctions of the sample 1, while the biased PL image can reflect data for the carrier distribution under different energy band changes and the distribution of luminescence characteristics at different depths of the sample 1.

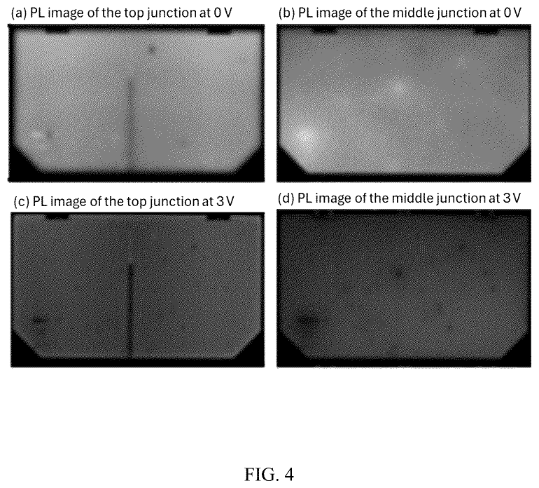

FIG. 4 shows a measurement result of a multi-junction solar cell by utilizing the photoluminescence (PL) image inspection system 100 according to an embodiment of the present invention. In this embodiment, the multi-junction solar cell is an Indium gallium phosphide/gallium arsenide/germanium (InGaP/GaAs/Ge) multi-junction solar cell. A voltage of 0V or 3V output by the voltage source 22 is applied to the InGaP/GaAs/Ge multi-junction solar cell. Then, the detection module 3 is utilized to capture photoluminescence images (PL Images) of different junctions of the InGaP/GaAs/Ge multi-junction solar cells. As shown in FIG. 4, the image 4(a) is the photoluminescence image of the top junction of the InGaP/GaAs/Ge multi-junction solar cells at the voltage of 0V; the image 4(b) is the photoluminescence image of the middle junction of the InGaP/GaAs/Ge multi-junction solar cells at the voltage of 0V; the image 4(c) is the photoluminescence image of the top junction of the InGaP/GaAs/Ge multi-junction solar cells at the voltage of 3V; the image 4(d) is the photoluminescence image of the middle junction of the InGaP/GaAs/Ge multi-junction solar cells at the voltage of 3V. In the photoluminescence (PL) images of FIG. 4, the bright and dark spots are epitaxial defects, and the long dark lines are broken metal lines on the front of the InGaP/GaAs/Ge multi-junction solar cell.

In summary, the photoluminescence (PL) image inspection system 100 according to the present invention which includes the photoelectric excitation module 2 with the light source 21 and the voltage source 22 can achieve a large-area detection for the sample 1 as well as provide a distribution of luminescence characteristics in the depth direction. Further, an output voltage of the voltage source 22 is automatically controlled by a program. When the sample 1 is to be measured under different conditions, there is no need to manually remove and reinstall the sample 1 or set the measurement parameters. Therefore, the photoluminescence (PL) image inspection system 100 according to the present invention is very convenient to use. Moreover, the overall detection speed can also be improved. Hence, the photoluminescence (PL) image inspection system 100 according to the present invention has the advantages of fast detection speed and high efficiency and is a very practical and multi-functional detection device.

The present invention has been described in terms of particular embodiments found or proposed by the inventor to comprise preferred methods for the practice of the present invention. It will be appreciated by those skilled in the art that, in light of the present disclosure, numerous modifications and changes can be made in the particular embodiments exemplified without departing from the intended scope of the invention. Moreover, due to biological functional equivalency considerations, changes can be made in methods, structures, and compounds without affecting the biological action in kind or amount. All such modifications are intended to be included within the scope of the appended claims.

What is claimed is:

1. A photoluminescence image inspection system for multi-junction solar cells, including:
a photoelectric excitation module adapted to illuminate a multi-junction solar cell to excite the multi-junction solar cell to emit light and including a light source and a voltage source, wherein the light source is used to provide light irradiation to the multi-junction solar cell; the voltage source is used to provide a voltage to the multi-junction solar cell;
a detection module disposed on one side of the photoelectric excitation module and adapted to capture a photoluminescence signal of the multi-junction solar cell; and
a filter module disposed in front of the detection module for filtering out light emitted from the light source in the same wavelength band as the photoluminescence signal of the multi-junction solar cell.

2. The photoluminescence image inspection system for multi-junction solar cells of claim 1, wherein the light source of the photoelectric excitation module includes a wavelength-adjustable light source with a wavelength ranging from 250 to 1500 nm.

3. The photoluminescence image inspection system for multi-junction solar cells of claim 1, wherein a passband of the filter module is adjusted according to different types of multi-junction solar cells.

4. The photoluminescence image inspection system for multi-junction solar cells of claim 1, wherein the detection module includes a charge-coupled device (CCD) or a complementary metal oxide semiconductor (CMOS) camera or a hyperspectrometer, and the detection module includes a cooling device to reduce an impact of thermal noise on detection.

5. The photoluminescence image inspection system for multi-junction solar cells of claim 1, wherein the voltage source of the photoelectric excitation module is adapted to provide a bias voltage to the multi-junction solar cell.
